(19) United States
(12) Patent Application Publication
(10) Pub. No.: US 2021/0082290 A1
(43) Pub. Date: Mar. 18, 2021

(54) DETERMINING AN AIRPORT FOR LANDING AN AIRCRAFT

(71) Applicant: The Boeing Company, Chicago, IL (US)

(72) Inventors: Nils Kneuper, Bergkamen (DE); Hendrik Schoniger, Dreieich (DE); Jonas Schulze, Darmstadt (DE)

(21) Appl. No.: 16/569,858

(22) Filed: Sep. 13, 2019

(51) Int. Cl. G08G 5/00

(52) U.S. Cl. CPC G08G 5/0039; G08G 5/0047

(57) ABSTRACT

An apparatus is provided. The apparatus receives information that describes a current state of the aircraft. The current state affects range of the aircraft from a current position of the aircraft. The apparatus predicts a current range of the aircraft from the information. The current range indicates range of the aircraft in any direction from the current position. The apparatus also determines candidate airports within the current range of the aircraft, and predicts remaining fuel on board after landing at respective ones of the candidate airports. The apparatus further selects an airport from those of the candidate airports at which the aircraft is predicted to have a positive amount of the remaining fuel on board as predicted, and presents the current range and the airport to a user for landing the aircraft at the airport.

### TECHNOLOGICAL FIELD

The present disclosure relates generally to landing an aircraft, and in particular, to determining an airport for landing an aircraft.

### BACKGROUND

An event may occur during a flight of an aircraft to a destination airport that necessitates urgently landing the aircraft. Based on the conventional planning procedure, the flight route is planned to ensure that the aircraft can reach alternate airports even during an urgent situation, such as when one engine is out, in a certain time period. However, the conventional planning procedure may not consider external conditions, such as headwinds, terrain or non-engine related adverse aircraft conditions. Instead, the conventional planning procedure may only consider an assumed or expected worst case situation that may not be realistic. Based on the conventional planning procedure, the pilot of the aircraft may be able to find the nearest alternate airport. However, in a situation that the nearest alternate airport may not be suitable for landing, the pilot may have to manually evaluate the current state of the aircraft and identify and navigate toward another alternate airport reachable by the aircraft, which increases the burden of the pilot.

Therefore, it would be desirable to have a system and method that takes into account at least some of the issues discussed above, as well as other possible issues.

### BRIEF SUMMARY

Example implementations of the present disclosure are directed to determining an airport for landing an aircraft, and in a manner that can increase situational awareness on alternate airports when an engine-out event occurs. Example implementations can consider operational and environmental factors that affect a reachable range of the aircraft from a current position of the aircraft, and can provide dynamic ranges to the pilot. Compared to conventional solutions, example implementations can select an alternate airport in range of the aircraft based on a current state of the aircraft such as current position and current fuel on board, and also based on external conditions such as airport conditions, maneuver requirements and weather conditions.

The present disclosure thus includes, without limitation, the following example implementations.

Some example implementations provide a method of determining an airport for landing an aircraft. The method comprises: receiving information that describes a current state of the aircraft, including current position, current fuel on board, and operational and environmental factors that affect range of the aircraft from the current position; predicting a current range of the aircraft from the information, the current range indicating range of the aircraft in any direction from the current position; determining candidate airports within the current range of the aircraft; predicting remaining fuel on board after landing at respective ones of the candidate airports; selecting an airport from those of the candidate airports at which the aircraft is predicted to have a positive amount of the remaining fuel on board; and presenting the current range and the airport to a user for landing the aircraft at the airport.

In some example implementations of the method of any preceding example implementation, or any combination of preceding example implementations, predicting the current range of the aircraft includes predicting the current range in any direction extending from the current position to a perimeter of a circular or non-circular closed shape, and presenting the current range includes presenting the current position, the current range and the circular or non-circular closed shape.

In some example implementations of the method of any preceding example implementation, or any combination of preceding example implementations, predicting the current range of the aircraft includes predicting the current range for each of a plurality of flight times.

In some example implementations of the method of any preceding example implementation, or any combination of preceding example implementations, the operational factors include airport conditions of the candidate airports and maneuver requirements to land at the candidate airports, and the environmental factors include weather conditions, and selecting the airport includes selecting the airport based on the remaining fuel on board as predicted, the airport conditions, the maneuver requirements and the weather conditions.

In some example implementations of the method of any preceding example implementation, or any combination of preceding example implementations, selecting the airport includes selecting the airport from those of the candidate airports at which the aircraft is predicted to have the positive amount of the remaining fuel on board at or above a threshold amount of remaining fuel on board.

In some example implementations of the method of any preceding example implementation, or any combination of preceding example implementations, presenting the current range and the airport to the user includes presenting a flight path of the aircraft to the airport.

In some example implementations of the method of any preceding example implementation, or any combination of preceding example implementations, receiving information that describes the current state of the aircraft, and predicting the current range of the aircraft, includes repeatedly receiving information that describes the current state of the aircraft, and predicting the current range of the aircraft, the current range being variable with the current state of the aircraft and thereby the information that describes the current state.

In some example implementations of the method of any preceding example implementation, or any combination of preceding example implementations, receiving information includes receiving information that describes the current state of the aircraft in response to detecting an engine-out event of the aircraft during a flight to a destination airport.

In some example implementations of the method of any preceding example implementation, or any combination of preceding example implementations, determining candidate airports includes determining candidate airports suitable for turns of the aircraft and landing of the aircraft having a specific type.

In some example implementations of the method of any preceding example implementation, or any combination of preceding example implementations, the method further comprises determining flight paths of the aircraft to respective ones of the candidate airports, the flight paths indicating altitudes and speeds of the aircraft to respective ones of the candidate airports, and runways to land at respective ones of the candidate airports, and predicting remaining fuel on board includes predicting remaining fuel on board following respective ones of the flight paths, after landing at respective ones of the candidate airports.

In some example implementations of the method of any preceding example implementation, or any combination of preceding example implementations, the current range indicates range of the aircraft in any direction from the current position until fuel on board is zero.

Some example implementations provide an apparatus for determining an airport for landing an aircraft. The apparatus comprises a processor and a memory storing executable instructions that, in response to execution by the processor, cause the apparatus to at least perform the method of any preceding example implementation, or any combination of any preceding example implementations.

Some example implementations provide a computer-readable storage medium for determining an airport for landing an aircraft. The computer-readable storage medium is non-transitory and has computer-readable program code stored therein that in response to execution by a processor, causes an apparatus to at least perform the method of any preceding example implementation, or any combination thereof.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a system for determining an airport for landing an aircraft, according to example implementations of the present disclosure;

FIG. 2 illustrates a flowchart of various operations in a method of determining an airport for landing an aircraft, according to example implementations of the present disclosure;

FIG. 3 illustrates a flowchart of various operations in a method of determining an airport for landing an aircraft, according to a more particular example implementation of the present disclosure;

FIG. 4 illustrates a flowchart of various operations in a method of determining an airport for landing an aircraft, according to another example implementation of the present disclosure;

FIG. 5 illustrates a diagram showing ranges of the aircraft, according to example implementations of the present disclosure; and

FIG. 6 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Also, something may be described as being above something else (unless otherwise indicated) may instead be below, and vice versa; and similarly, something described as being to the left of something else may instead be to the right, and vice versa. Like reference numerals refer to like elements throughout.

Example implementations of the present disclosure are generally directed to landing an aircraft, and in particular, to determining an airport for landing an aircraft.

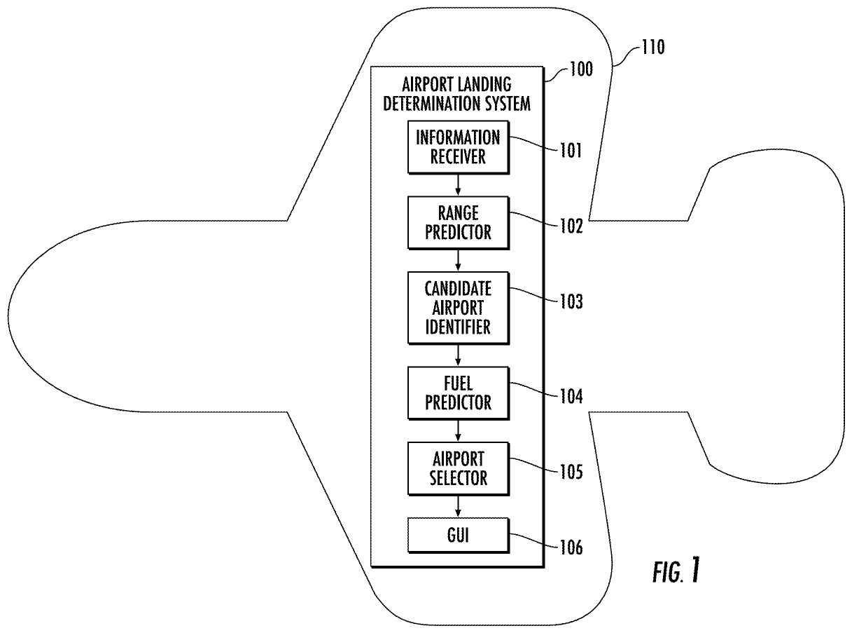

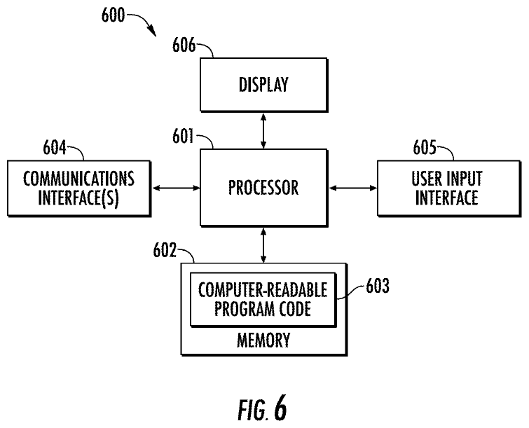

FIG. 1 illustrates a system 100 for determining an airport for landing an aircraft 110, according to example implementations of the present disclosure. In some examples, as described in greater detail with reference to FIG. 6, the system may be implemented by an apparatus for determining an airport for landing an aircraft. In one example, the system may be on-board the aircraft. In another example, the system may be remote from but in communication with the aircraft over a suitable wireless communication link.

The system 100 includes any of a number of different subsystems (each an individual system) for performing one or more functions or operations. As shown, in some examples, the system includes one or more of each of an information receiver 101, a range predictor 102, a candidate airport identifier 103, a fuel predictor 104, an airport selector 105 and a graphical user interface (GUI) 106. The subsystems may be co-located or directly coupled to one another, or in some examples, various ones of the subsystems may communicate with one another across one or more computer networks. Further, although shown as part of the system, it should be understood that any one or more of the information receiver, range predictor, candidate airport identifier, fuel predictor, airport selector and GUI may function or operate as a separate system without regard to any of the other subsystems. It should also be understood that the system may include one or more additional or alternative subsystems than those shown in FIG. 1.

In some implementations, the information receiver 101 is configured to receive information that describes a current state of the aircraft 110. The information includes current position of the aircraft, current fuel on board, and operational and environmental factors that affect range of the aircraft from the current position. In some implementations, the information receiver is configured to receive information that describes the current state of the aircraft in response to detecting an engine-out event of the aircraft during a flight to a destination airport.

The information receiver 101 can provide the received information to the range predictor 102. In some implementations, the range predictor is configured to predict a current range of the aircraft 110 from the information. The current range indicates range of the aircraft in any direction from the current position of the aircraft. In some implementations, the range predictor is configured to predict the current range for each of a plurality of flight times. For example, the range predictor may predict a range reachable by the aircraft for each of a flight time of 120 minutes, 60 minutes and 30 minutes. In some implementations, the current range indicates range of the aircraft in any direction from the current position until fuel on board is zero or close to zero.

The predicted current range may be dynamically updated. In some implementations, the information receiver 101 is configured to repeatedly receive information that describes the current state of the aircraft 110, and the range predictor 102 is configured to repeatedly predict the current range of the aircraft. The current range is variable with the current state of the aircraft and thereby the information that describes the current state.

The range predictor 102 can provide the predicted current range to the candidate airport identifier 103. In some implementations, the candidate airport identifier is configured to determine candidate airports within the current range of the aircraft 110. In some implementations, the candidate airport identifier is configured to determine candidate airports suitable for turns of the aircraft and landing of the aircraft having a specific type. For example, the candidate airport identifier can determine candidate airports suitable for turns and landing of a large aircraft.

The candidate airport identifier 103 can provide the determined candidate airports to the fuel predictor 104. In some implementations, the fuel predictor is configured to predict remaining fuel on board after landing at respective ones of the candidate airports. In some implementations, the candidate airport identifier is configured to determine flight paths of the aircraft to respective ones of the candidate airports. The flight paths indicate altitudes and speeds of the aircraft to respective ones of the candidate airports, and runways to land at respective ones of the candidate airports. In these implementations, the fuel predictor is configured to predict remaining fuel on board following respective ones of the flight paths, after landing at respective ones of the candidate airports.

The fuel predictor 104 can provide the predicted remaining fuel to the airport selector 105, which in some implementations is configured to select an airport from those of the candidate airports at which the aircraft 110 is predicted to have a positive amount of the remaining fuel on board. In some implementations, the airport selector is configured to select the airport from those of the candidate airports at which the aircraft 110 is predicted to have the positive amount of the remaining fuel on board at or above a threshold amount of remaining fuel on board.

In some implementations, the operational factors include airport conditions of the candidate airports and maneuver requirements to land at the candidate airports, and the environmental factors include weather conditions such as wind strength and direction. In these implementations, the airport selector 105 is configured to select the airport based on the remaining fuel on board as predicted, the airport conditions, the maneuver requirements and the weather conditions.

In some implementations, the GUI 106 is configured to present the current range and the airport to a user for landing the aircraft 110 at the airport selected by the airport selector 105. In some implementations, the GUI is configured to present a flight path of the aircraft to the airport.

The predicted current range may have a regular or non-regular shape. In some implementations, the range predictor 102 is configured to predict the current range in any direction extending from the current position to a perimeter of a circular or non-circular closed shape. In these implementations, the GUI 106 is configured to present the current position, the current range and the circular or non-circular closed shape to the user.

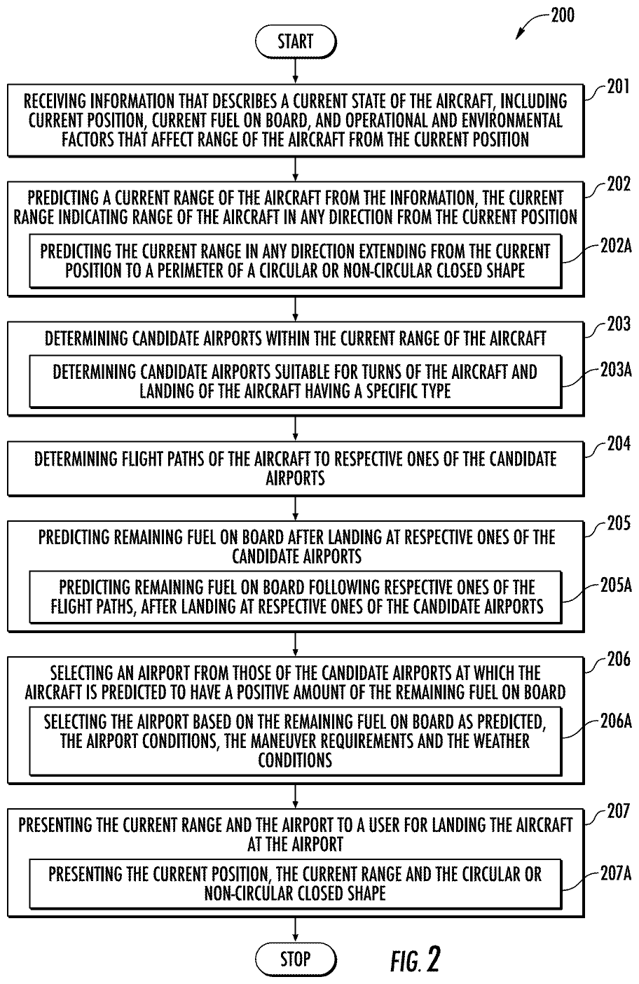

FIG. 2 illustrates a flowchart of various operations in a method 200 of determining an airport for landing the aircraft 110, according to example implementations of the present disclosure. As shown, at block 201, the method includes receiving information that describes a current state of the aircraft. The information includes current position, current fuel on board, and operational and environmental factors that affect range of the aircraft from the current position. At block 202, the method includes predicting a current range of the aircraft from the information. The current range indicates range of the aircraft in any direction from the current position. At block 202A, the method includes predicting the current range in any direction extending from the current position to a perimeter of a circular or non-circular closed shape. At block 203, the method includes determining candidate airports within the current range of the aircraft. At block 203A, the method includes determining candidate airports suitable for turns of the aircraft and landing of the aircraft having a specific type. At block 204, the method includes determining flight paths of the aircraft to respective ones of the candidate airports. At block 205, the method includes predicting remaining fuel on board after landing at respective ones of the candidate airports. At block 205A, the method includes predicting remaining fuel on board following respective ones of the flight paths, after landing at respective ones of the candidate airports. At block 206, the method includes selecting an airport from those of the candidate airports at which the aircraft is predicted to have a positive amount of the remaining fuel on board. At block 206A, the method includes selecting the airport based on the remaining fuel on board as predicted, the airport conditions, the maneuver requirements and the weather conditions. At block 207, the method includes presenting the current range and the airport to a user for landing the aircraft at the airport. In some examples, the method may further include landing the aircraft at the airport. At block 207A, the method includes presenting the current position, the current range and the circular or non-circular closed shape.

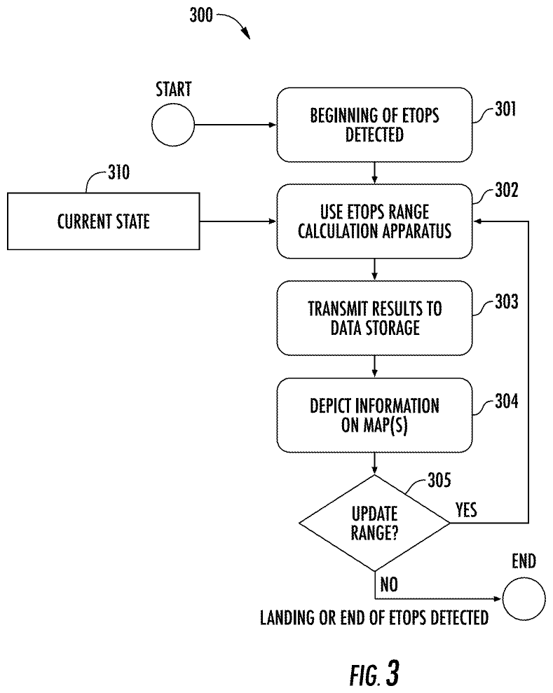

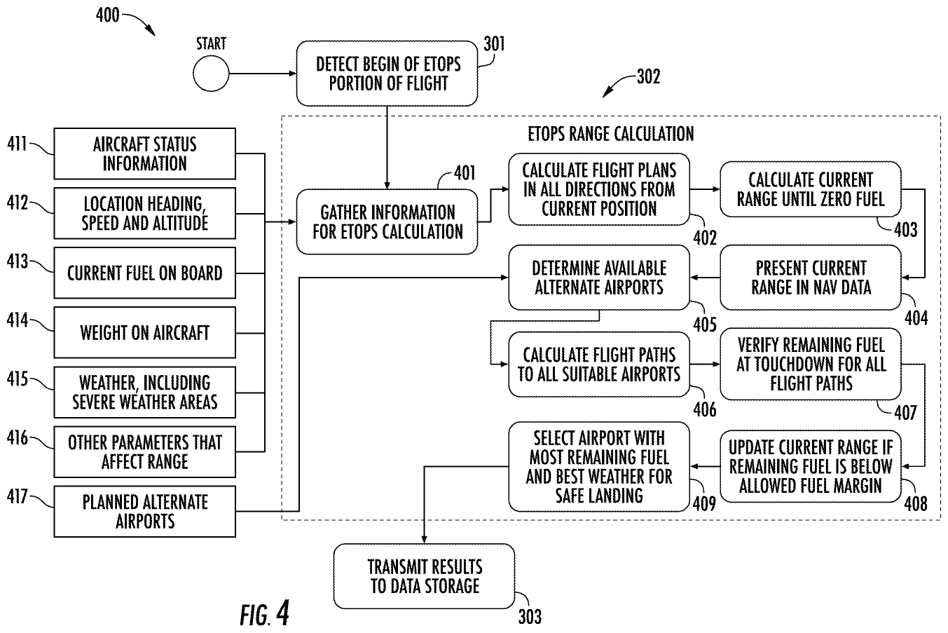

FIG. 3 illustrates a flowchart of various operations in a method 300 of determining an airport for landing the aircraft 110, according to a more particular example implementation of the present disclosure. In one example, as shown, at block 301, the beginning of following extended-range twin-engine operational performance standards (ETOPS) for a portion of flight is detected. The beginning of following ETOPS for a portion of flight may be detected due to an occurrence of an engine-out event. At block 302, the ETOPS range calculation apparatus can be used to predict the current range of the aircraft. The ETOPS range calculation apparatus may correspond to the system 100. In one example, the ETOPS range calculation apparatus can predict the current range of the aircraft based on the current state 310 of the aircraft. The operation at block 302 will be described in greater details with reference to FIG. 4 below.

In one example, after the current range of the aircraft 110 is predicted at block 302, the results can be transmitted to data storage, as shown at block 303. At block 304, the system 100, or more specifically the GUI 106 can depict information of the current range and a selected airport to a user (e.g., the pilot) for landing the aircraft at the airport. At block 305, the current range may be updated. For example, if the last predicted current range is predicted more than a time period (e.g., more than 5 minutes) ago or the direction of the aircraft is changed, the decision is Yes and the current range may be updated. In this situation, the method 300 may proceed from block 305 back to block 302. On the other hand, if the aircraft has landed or the end of ETOPS is detected, the decision is No and the current range may not be updated and the method 300 may end. In some examples, the method 300 may further include landing the aircraft at the selected airport.

FIG. 4 illustrates a flowchart of various operations in a method 400 of determining an airport for landing the aircraft 110, according to another example implementation of the present disclosure. In one example, similarly as in FIG. 3, after the beginning of following ETOPS for a portion of flight is detected at block 301, the ETOPS range calculation apparatus can be used to predict the current range of the aircraft at block 302. As shown, block 302 may include operations from block 401 to block 409.

In one example, at block 401, the information receiver 101 may gather information for ETOPS calculation for the aircraft 110. The information may include aircraft status information 411, location, heading, speed and altitude information 412, current fuel on aboard 413, weight of the aircraft 414, weather 415 (including severe weather areas), other parameters 416 that may affect range of the aircraft and the planned alternate airports 417. The above-mentioned information may be included in the current state 310 in FIG. 3.

In one example, after the information is gathered at block 401, the range predictor 102 may calculate flight plans in all directions from the current position of the aircraft 110 at block 402. At block 403, the range predictor may calculate the current range of the aircraft in any direction from the current position until fuel on board is zero. At block 404, the GUI 106 may present the current range in navigation data. At block 405, the candidate airport identifier 103 may determine candidate airports (e.g., available alternate airports) within the current range of the aircraft.

In one example, after the available alternate airports are determined at block 405, the candidate airport identifier 103 may calculate flight paths to all suitable airports at block 406. The candidate airport identifier may also determine standard terminal arrival route (STAR) and approach at block 406. At block 407, the fuel predictor 104 may verify remaining fuel on board at landing (e.g. at touchdown) for all flight paths. At block 408, the range predictor 102 may update the current range if the remaining fuel on board to arrive at an airport is below an allowed fuel margin. At block 409, the airport selector 105 may select the airport with most remaining fuel on board and best weather condition for safe landing. Then the results may be transmitted to data storage at block 303, similarly as in FIG. 3. In some examples, the method 400 may further include landing the aircraft at the selected airport.

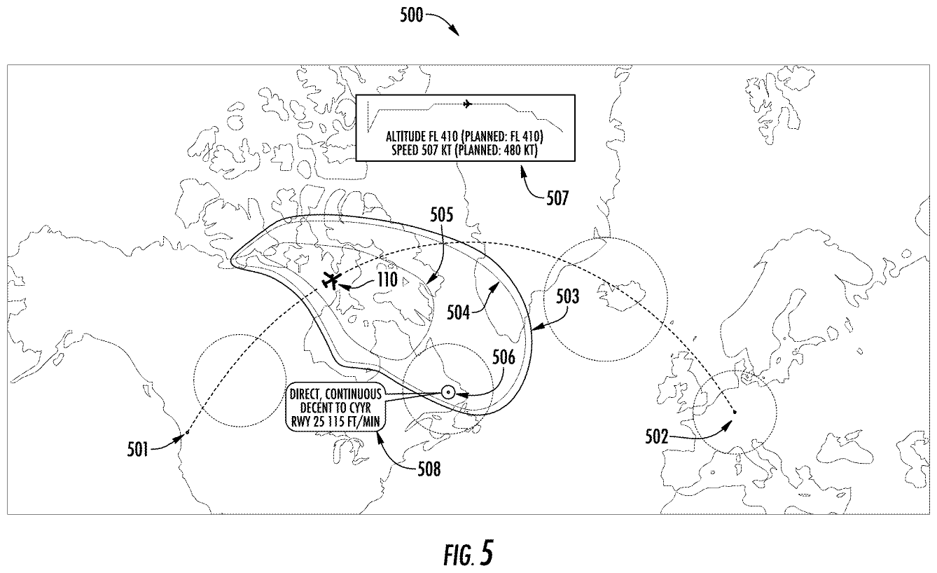

FIG. 5 illustrates a diagram 500 showing ranges of the aircraft 110, according to example implementations of the present disclosure. As shown, in one example, the aircraft is planned to fly from a departure airport 501 to a destination airport 502. The system 100 may be on aboard the aircraft 110. During the flight, an engine-out event is detected. The information receiver 101 may receive information that describes a current state of the aircraft. The information may include current position, current fuel on board, and operational and environmental factors that affect range of the aircraft from the current position.

In one example, the range predictor 102 may predict a current range of the aircraft 110 from the received information. The current range may indicate range of the aircraft in any direction from the current position. In one example, the range predictor may predict the current range for each of a plurality of flight times. For example, the range predictor may predict a range 503 reachable by the aircraft with a flight time of 120 minutes, a range 504 reachable by the aircraft with a flight time of 60 minutes, and a range 505 reachable by the aircraft with a flight time of 30 minutes.

In one example, candidate airport identifier 103 may determine candidate airports within the current range of the aircraft 110. The fuel predictor 104 may predict remaining fuel on board after landing at respective ones of the candidate airports. The airport selector 105 may select an airport 506 from those of the candidate airports at which the aircraft is predicted to have a positive amount of the remaining fuel on board. The GUI 106 may present the current range and the airport to the pilot for landing the aircraft at the airport.

In one example, the GUI 106 may also present information of altitude and speed of the aircraft 110, as indicated by block 507. For example, the block 507 may indicate that the actual altitude of the aircraft is 410 flight level (FL) and the planned altitude is 410 FL, and the actual speed of the aircraft is 507 knots (KT) and the planned altitude is 480 KT. In another example, the GUI may also present a flight path of the aircraft to the airport, as indicated by block 508. The flight path may indicate how to arrive at the selected airport, the airport code, the runway (RWY) number and the speed to land at the airport. For example, the block 508 may present a flight path indicating “Direct, Continuous Decent to CYYR RWY 25 115 FT/MIN” to the pilot for landing the aircraft at the airport.

According to example implementations of the present disclosure, the system 100 and its subsystems including the information receiver 101, range predictor 102, candidate airport identifier 103, fuel predictor 104, airport selector 105 and GUI 106 may be implemented by various means. Means for implementing the system and its subsystems may include hardware, alone or under direction of one or more computer programs from a computer-readable storage medium. In some examples, one or more apparatuses may be configured to function as or otherwise implement the system and its subsystems shown and described herein. In examples involving more than one apparatus, the respective apparatuses may be connected to or otherwise in communication with one another in a number of different manners, such as directly or indirectly via a wired or wireless network or the like.

FIG. 6 illustrates an apparatus 600 according to some example implementations. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, processor 601 (e.g., processing circuitry) connected to a memory 602 (e.g., storage device). In some examples, the apparatus 600 implements the system 100.

The processor 601 may be composed of one or more processors alone or in combination with one or more memories. The processor is generally any piece of computer hardware that is capable of processing information such as, for example, data, computer programs and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 602 (of the same or another apparatus).

The processor 601 may be a number of processors, a multi-core processor or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program. In either instance, the processor may be appropriately programmed to perform functions or operations according to example implementations of the present disclosure.

The memory 602 is generally any piece of computer hardware that is capable of storing information such as, for example, data, computer programs (e.g., computer-readable program code 603) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 602, the processor 601 may also be connected to one or more interfaces for displaying, transmitting and/or receiving information. The interfaces may include a communications interface 604 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 606 and/or at least one user input interface 605 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, keyboard or keypad, joystick, touch-sensitive surface (separate from or integrated into a touchscreen), biometric sensor or the like. The user interfaces may further include one or more interfaces for communicating with peripherals such as printers, scanners or the like. In some examples, the user interfaces include the GUI 106.

As indicated above, program code instructions may be stored in memory, and executed by processor that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an apparatus 600 may include a processor 601 and a computer-readable storage medium or memory 602 coupled to the processor, where the processor is configured to execute computer-readable program code 603 stored in the memory. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for determining an airport for landing an aircraft, the apparatus comprising a processor and a memory storing executable instructions that, in response to execution by the processor, cause the apparatus to:
receive information that describes a current state of the aircraft, including current position, current fuel on board, and operational and environmental factors that affect range of the aircraft from the current position;
predict a current range of the aircraft from the information, the current range indicating range of the aircraft in any direction from the current position;
determine candidate airports within the current range of the aircraft;
predict remaining fuel on board after landing at respective ones of the candidate airports;
select an airport from those of the candidate airports at which the aircraft is predicted to have a positive amount of the remaining fuel on board; and
present the current range and the airport to a user for landing the aircraft at the airport.

2. The apparatus of claim 1, wherein the apparatus being caused to predict the current range of the aircraft includes at least one of:
being caused to predict the current range in any direction extending from the current position to a perimeter of a circular or non-circular closed shape, wherein the apparatus being caused to present the current range includes being caused to present the current position, the current range and the circular or non-circular closed shape; and
predict the current range for each of a plurality of flight times.

3. The apparatus of claim 1, wherein the operational factors include airport conditions of the candidate airports and maneuver requirements to land at the candidate airports, and the environmental factors include weather conditions, and the apparatus being caused to select the airport includes being caused to select the airport based on the remaining fuel on board as predicted, the airport conditions, the maneuver requirements and the weather conditions.

4. The apparatus of claim 1, wherein the apparatus being caused to select the airport includes being caused to select the airport from those of the candidate airports at which the aircraft is predicted to have the positive amount of the remaining fuel on board at or above a threshold amount of remaining fuel on board.

5. The apparatus of claim 1, wherein the apparatus being caused to present the current range and the airport to the user includes being caused to present a flight path of the aircraft to the airport.

6. The apparatus of claim 1, wherein the apparatus being caused to receive information that describes the current state of the aircraft, and predict the current range of the aircraft, includes being caused to repeatedly receive information that describes the current state of the aircraft, and predict the current range of the aircraft, the current range being variable with the current state of the aircraft and thereby the information that describes the current state.

7. The apparatus of claim 1, wherein the apparatus being caused to receive information includes being caused to receive information that describes the current state of the aircraft in response to detecting an engine-out event of the aircraft during a flight to a destination airport.

8. The apparatus of claim 1, wherein the apparatus being caused to determine candidate airports includes being caused to determine candidate airports suitable for turns of the aircraft and landing of the aircraft having a specific type.

9. The apparatus of claim 1, wherein the memory stores further executable instructions that, in response to execution by the processor, cause the apparatus to further:
determine flight paths of the aircraft to respective ones of the candidate airports, the flight paths indicating altitudes and speeds of the aircraft to respective ones of the candidate airports, and runways to land at respective ones of the candidate airports, and
wherein the apparatus being caused to predict remaining fuel on board includes being caused to predict remaining fuel on board following respective ones of the flight paths, after landing at respective ones of the candidate airports.

10. The apparatus of claim 1, wherein the current range indicates range of the aircraft in any direction from the current position until fuel on board is zero.

11. A method of determining an airport for landing an aircraft, comprising:
receiving information that describes a current state of the aircraft, including current position, current fuel on board, and operational and environmental factors that affect range of the aircraft from the current position;
predicting a current range of the aircraft from the information, the current range indicating range of the aircraft in any direction from the current position;
determining candidate airports within the current range of the aircraft;
predicting remaining fuel on board after landing at respective ones of the candidate airports;
selecting an airport from those of the candidate airports at which the aircraft is predicted to have a positive amount of the remaining fuel on board; and
presenting the current range and the airport to a user for landing the aircraft at the airport.

12. The method of claim 11, wherein predicting the current range of the aircraft includes at least one of:
predicting the current range in any direction extending from the current position to a perimeter of a circular or non-circular closed shape, wherein presenting the current range includes presenting the current position, the current range and the circular or non-circular closed shape; and
predicting the current range for each of a plurality of flight times.

13. The method of claim 11, wherein the operational factors include airport conditions of the candidate airports and maneuver requirements to land at the candidate airports, and the environmental factors include weather conditions, and selecting the airport includes selecting the airport based on the remaining fuel on board as predicted, the airport conditions, the maneuver requirements and the weather conditions.

14. The method of claim 11, wherein selecting the airport includes selecting the airport from those of the candidate airports at which the aircraft is predicted to have the positive amount of the remaining fuel on board at or above a threshold amount of remaining fuel on board.

15. The method of claim 11, wherein presenting the current range and the airport to the user includes presenting a flight path of the aircraft to the airport.

16. The method of claim 11, wherein receiving information that describes the current state of the aircraft, and predicting the current range of the aircraft, includes repeatedly receiving information that describes the current state of the aircraft, and predicting the current range of the aircraft, the current range being variable with the current state of the aircraft and thereby the information that describes the current state.

17. The method of claim 11, wherein receiving information includes receiving information that describes the current state of the aircraft in response to detecting an engine-out event of the aircraft during a flight to a destination airport.

18. The method of claim 11, wherein determining candidate airports includes determining candidate airports suitable for turns of the aircraft and landing of the aircraft having a specific type.

19. The method of claim 11, further comprising:
determining flight paths of the aircraft to respective ones of the candidate airports, the flight paths indicating altitudes and speeds of the aircraft to respective ones of the candidate airports, and runways to land at respective ones of the candidate airports, and
wherein predicting remaining fuel on board includes predicting remaining fuel on board following respective ones of the flight paths, after landing at respective ones of the candidate airports.

20. The method of claim 11, wherein the current range indicates range of the aircraft in any direction from the current position until fuel on board is zero.
